(19) United States
(12) Patent Application Publication
(10) Pub. No.: US 2010/0156881 A1
(43) Pub. Date: Jun. 24, 2010

(54) IMAGE DISPLAY DEVICE

(75) Inventors: Tohru Kohno, Koganei (JP); Hajime Akimoto, Kokubunji (JP); Hiroshi Kageyama, Hachioji (JP); Takahide Kuranaga, Tachikawa (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignees: Hitachi Displays, Ltd.; Canon Kabushiki Kaisha

(21) Appl. No.: 12/647,013

(22) Filed: Dec. 24, 2009

(30) Foreign Application Priority Data
Dec. 24, 2008 (JP) 2008-327780
Sep. 10, 2009 (JP) 2009-208837

(51) Int. Cl. G06F 3/038

(52) U.S. Cl. 345/213

(57) ABSTRACT

An image display device includes a plurality of pixels. Each of the plurality of pixels includes a self light-emitting element and a driving transistor configured to drive the self light-emitting element based on an inputted image voltage. The image display device also includes a current source configured to supply a constant current to the driving transistor and a detection section connected to a source electrode of a driving transistor of each of the plurality of pixels. The current source is connected to the source electrode of the driving transistor. The detection section detects a source voltage of the driving transistor to which the constant current is supplied during a detection period.

### CROSS-REFERENCE TO RELATED APPLICATION

The present application claims priority from Japanese Applications JP2008-327780 filed on Dec. 24, 2008 and JP2009-208837 filed on Sep. 10, 2009, the contents of which are hereby incorporated by reference into this application.

### BACKGROUND OF THE INVENTION

1. Field of the Invention

The present invention relates to an image display device using, for example, an organic electroluminescence (EL) element, and more particularly, to an image display device capable of displaying a high-quality image with high definition at low voltage.

2. Description of the Related Art

In recent years, the demand for flat panel display devices instead of cathode ray tube (CRT) display devices, which are the mainstream of conventional display devices, has been increased. In particular, an organic EL display device using an organic EL element such as an organic light-emitting diode (OLED) is excellent in terms of power consumption, weight, thickness, moving picture characteristic, view angle, and the like, and, hence, the development and practical use are advanced.

In the organic EL display device, each pixel has a driving transistor for driving the organic EL element. When a fluctuation in threshold voltage Vth of the driving transistor of each pixel is large, a fluctuation in light emission characteristic of each pixel occurs to reduce the uniformity of a screen, and, hence, high quality cannot be maintained.

The driving transistor for driving the organic EL element is normally a thin film transistor. The thin film transistor has a large fluctuation in threshold voltage Vth.

Therefore, the organic EL display device has the following problem. That is, the fluctuation in threshold voltage Vth of the driving transistor of each pixel becomes larger, and, hence, the fluctuation in light emission characteristic of each pixel occurs to reduce the uniformity of the screen. Thus, high quality cannot be maintained.

In view of above, it is necessary for the organic EL display device to cancel the fluctuation in threshold voltage Vth of the driving transistor of each pixel.

An image display device to cancel the fluctuation in threshold voltage Vth of the driving transistor of each pixel is disclosed in, for example, Dawson, SID 98 Digest, pp. 11-14, JP 2003-122301 A, JP 2004-264793 A, JP 2007-018876 A, and JP 2008-032761 A.

FIG. 12A is a circuit diagram illustrating an equivalent circuit of an example of a pixel in a conventional organic EL display device.

FIG. 12B is an explanatory diagram illustrating an operation of the pixel illustrated in FIG. 12A.

The pixel illustrated in FIG. 12A is the most typical pixel in a voltage program system. A signal line 12, a reset line 7, a selection switch line Y, a turn-on switch line 21, and a power supply line 6 are connected to a pixel 1 illustrated in FIG. 12A as inputs thereof.

The pixel 1 includes an organic electroluminescence element (hereinafter referred to as an organic EL element) 2 serving as a light emitting element.

A cathode electrode of the organic EL element 2 is connected to a common ground line, and an anode electrode of the organic EL element 2 is connected to the power supply line 6 through a p-type thin film transistor (hereinafter referred to as a driving TFT) 4 and a turn-on switch element 20 that includes a p-type thin film transistor.

In addition, a second holding capacitor element 30 is connected between a gate electrode and a source electrode of the driving TFT 4. A reset switch element 5 including a p-type thin film transistor is provided between a drain electrode and the gate electrode of the driving TFT 4. The gate electrode of the driving TFT 4 is connected to the signal line 12 through a first holding capacitor element 3 and a selection switch element 32 including a p-type thin film transistor.

A gate electrode of the reset switch element 5 is connected to the reset line 7. A gate electrode of the selection switch element 32 is connected to the selection switch line Y. A gate electrode of the turn-on switch element 20 is connected to the turn-on switch line 21.

In the organic EL display device having the pixel 1 illustrated in FIG. 12A, one frame period includes a write period and a light emission period. An image voltage is written into the pixel 1 during the write period. Light is emitted for the organic EL display device to display during the light emission period. The writing of the image voltage is performed for one display line, that is, for each reset line 7.

Hereinafter, an operation during each of the write period and the light emission period is described.

First, as illustrated in FIG. 125, during a period between times t1 and t2 of the write period, the reset switch element 5 and the turn-on switch element 20 are turned on. Thus, the driving TFT 4 becomes a diode connection in which the gate electrode is connected to the drain electrode so that a voltage of the gate electrode of the driving TFT 4, which has been stored in the first holding capacitor element 3 in a preceding field, is cleared.

Next, when the turn-on switch element 20 is turned off at the time t2, the driving TFT 4 and the organic EL element 2 forcedly become in a current off state. At this time, the gate electrode and the drain electrode of the driving TFT 4 are short-circuited through the reset switch element 5, and, hence, the voltage of the gate electrode of the driving TFT 4, which is one end of the first holding capacitor element 3, is automatically reset to a voltage (VDD-Vth) that is lower than a voltage VDD on the power supply line 6 by a threshold voltage Vth.

During a period tc, a predetermined voltage (reference voltage) is supplied to the signal line 12, and the selection switch element 32 is turned on during the period tc. Therefore, the predetermined voltage (reference voltage) is input from the signal line 12 to the other end of the first holding capacitor element 3.

Next, at a time t3, the reset switch element 5 is turned off. After that, during a data transmission period, an analog image voltage is supplied to the signal line 12, and the image voltage is input to the other end of the first holding capacitor element 3.

During the light emission period, the reset switch element 5 and the selection switch element 32 are turned off, and the turn-on switch element 20 is turned on so that the organic EL element 2 emits light.

During the light emission period, a voltage corresponding to a change of the image voltage with respect to the reference voltage is applied to the gate electrode of the driving TFT 4, and a current corresponding to the applied voltage flows through the organic EL element 2 so as to adjust light emission luminance.

As described above, in each pixel 1 of the organic EL display device illustrated in FIG. 12A, during the period tc, the voltage of the gate electrode of the driving TFT 4 is automatically reset to the voltage (VDD-Vth) lower than the voltage VDD on the power supply line 6 by the threshold voltage Vth. Therefore, the fluctuation in threshold voltage of the driving TFT 4 is suppressed, and, hence, the light emission with high uniformity is realized.

FIG. 13A is a circuit diagram illustrating an equivalent circuit of another example of the pixel of the conventional organic EL display device.

FIG. 13B is an explanatory diagram illustrating an operation of the pixel illustrated in FIG. 13A.

In the pixel illustrated in FIG. 13A, the number of elements such as the transistors included in the pixel is reduced compared with the pixel illustrated in FIG. 12A.

As illustrated in FIG. 13A, a cathode electrode of the organic EL element 2 is connected to the common ground line, and an anode electrode of the organic EL element 2 is connected to the power supply line 6 through a turn-on switch element 20 including an n-type thin film transistor and the driving TFT (p-type thin film transistor) 4.

A reset switch element 5 including an n-type thin film transistor is provided between the drain electrode and the gate electrode of the driving TFT 4. The gate electrode of the driving TFT 4 is connected to the signal line 12 through a holding capacitor element 3.

A gate electrode of the reset switch element 5 is connected to the reset line 7. A gate electrode of the turn-on switch element 20 is connected to the turn-on switch line 21.

In the case of the pixel illustrated in FIG. 13A, because the number of elements included in the pixel is reduced, it is necessary to divide each frame period into the write period and the light emission period.

Hereinafter, an operation during each of the write period and the light emission period is described.

First, at a time t1 of the write period, the turn-on switch element 20 and the reset switch element 5 are turned on. Thus, the driving TFT 4 becomes a diode connection in which the gate electrode is connected to the drain electrode so that a voltage of the gate electrode of the driving TFT 4, which has been stored in the holding capacitor element 3 in a preceding field, is cleared.

Next, when the turn-on switch element 20 is turned off at a time t2, the driving TFT 4 and the organic EL element 2 forcedly become in a current off state. At this time, because the gate electrode and the drain electrode of the driving TFT 4 are short-circuited through the reset switch element 5, the voltage of the gate electrode of the driving TFT 4 that is one end of the holding capacitor element 3 is automatically reset to a voltage lower than a voltage on the power supply line 6 by a threshold voltage Vth. At this time, an analog image voltage Vs (k) is input from the signal line 12 to the other end of the holding capacitor element 3.

Next, at a time t3, the reset switch element 5 is turned off, and the writing of the analog image voltage into the pixel is completed. That is, the writing of an analog image voltage into a pixel is sequentially performed for each display line. After the writing into each pixel is performed, the “write period” of a frame is completed.

During the “light emission period” of the frame, the reset switch element 5 is turned off, and the turn-on switch element 20 of each pixel is in an on-state.

At this time, a triangular wave voltage illustrated in FIG. 13B is input to the signal line 12. The organic EL element 2 of each pixel is driven by the driving TFT 4 based on a voltage relationship between the analog image voltage Vs (k) that is written in advance and the triangular wave voltage that is applied to the signal line 12.

At this time, where a mutual conductance (gm) of the driving TFT 4 is sufficiently large, the organic EL element 2 can be assumed to be driven in a digital manner so as to be turned on and off. That is, the organic EL element 2 continuously emits light at a substantially constant luminance during only a period that depends on the analog image voltage value Vs (k) written in advance. As a result, the modulation of the light emission time period is visually recognized as multi-gradation light emission.

FIG. 15A is a circuit diagram illustrating a schematic structure of a conventional organic EL display device.

In the conventional organic EL display device illustrated in FIG. 15A, a fluctuation in threshold voltage Vth of a driving TFT of each pixel is detected as a fluctuation in current and is compensated by an external system.

In the conventional organic EL display device illustrated in FIG. 15A, during a “detection period”, for example, an image voltage for each gradation is applied to the gate electrode of the driving TFT of each pixel in an organic EL display panel 100. At this time, a current flowing through the organic EL element of each pixel is detected by a detection section DET. In the detection section DET, a detected current is converted into a voltage by a current/voltage conversion section IVC and is output through a low-pass filter LPF.

The voltage output from the detection section DET is converted into a digital value by an A/D converter 106 and stored in a memory 104. The processing described above is executed based on an instruction from a CPU 105.

During the “light emission period”, image data corresponding to respective input color data Rdata, Gdata, and Bdata are read out from lookup tables 101 in synchronization with a clock CK. A correction offset generating circuit 103 generates correction data based on data stored in the memory 104.

The correction data are added to the image data that is read out from the lookup tables 101. Then, the image data are converted into analog image voltages by D/A converters 102 and applied to the gate electrodes of the driving TFTs of the respective pixels in the organic EL display panel 100 so that the organic EL elements emit light.

FIG. 15B illustrates a structure of the organic EL display panel 100 illustrated in FIG. 15A. The organic EL display panel 100 includes a display section 113 having a plurality of pixels 112 provided therein, a pixel row selection circuit 108, and a pixel row selection circuit 109.

As illustrated in FIG. 15C, the signal line 12, the selection switch line Y, and the power supply line 6 are led to each pixel 112 as inputs thereof. The pixel 112 includes the organic EL element 2 serving as the light-emitting element. The cathode electrode of the organic EL element 2 is connected to the common ground line, and the anode electrode is connected to the power supply line 6 through the driving TFT 4.

The holding capacitor element 3 is connected between the gate electrode and the source electrode of the driving TFT 4. The gate electrode of the driving TFT 4 is connected to the signal line 12 through the selection switch element 32 including an n-type thin film transistor. The gate electrode of the selection switch element 32 is connected to the selection switch line Y.

The power supply line 6 and the gate electrode of the driving TFT 4 are connected to each other through a turn-off switch element 110.

The pixel row selection circuit 108 is connected to the selection switch line Y and controls the turn-on/off of the selection switch element 32. The pixel row selection circuit 109 controls the turn-on/off of the turn-off switch element 110 through a turn-off switch control line 111. When the turn-off switch element 110 of a pixel of which a current is not detected is selected and turned on, the gate electrode of the driving TFT 4 of a pixel other than a pixel of which a current is detected is connected to the power supply line 6 so that the driving TFT 4 is turned off. When such an operation is incorporated into each frame, both display and detection functions can be realized for each frame.

### SUMMARY OF THE INVENTION

In order to realize a high definition an organic EL display panel using the pixel illustrated in FIG. 12A or the pixel illustrated in FIG. 13A described above, the presence of the reset switch element 5 for canceling the fluctuation in threshold voltage Vth of the driving TFT 4 of each pixel limits a reduction in pixel size.

As illustrated in FIG. 14A, in thin film transistors, there is a fluctuation in leak currents, or there is a deviation of a leak current. In addition, FIGS. 14A and 14B are explanatory diagrams for explaining problems of the pixel illustrated in FIG. 12A and the pixel illustrated in FIG. 13A.

During the light emission period for which the reset switch element 5 is turned off, the holding capacitor element 3 is charged by a leak current of the reset switch element 5. When the leak current of the thin film transistor serving as the reset switch element 5 is large, the voltage of the gate electrode of the driving TFT 4 fluctuates. In order to prevent the light emission luminance of the organic EL element 2 from being affected by the voltage of the gate electrode of the driving TFT 4, it is necessary to increase a capacitance value of the holding capacitor element 3.

Also, when the thin film transistor serving as the reset switch element 5 has the deviation of the leak current, the voltage of the gate electrode of the driving TFT 4 fluctuates. Therefore, when pixels are to be displayed with the same gradation on the entire organic EL display panel, a weak luminance point as indicated by A illustrated in FIG. 14B occurs. In order to prevent the occurrence of the weak luminance point, it is necessary to maintain the capacitance value of the holding capacitor element 3 to a large value.

Therefore, there is a problem that the reset switch element 5 illustrated in FIGS. 12A and 13A prevents a display from realizing high definition in that an increase in the number of elements is increased and that the size of the holding capacitor element 3 included in the pixel is unnecessarily increased.

In the organic EL display device illustrated in FIG. 15A, when a current is converted into a voltage, it is necessary to set a resistance value of a resistor for converting the current into the voltage to a sufficiently large value such that the A/D converter 106 provided at the subsequent stage determines fluctuation characteristic.

In order to suppress a thermal noise that is generated from the resistor having the large resistance value, it is necessary to insert the low-pass filter LPF having a low cutoff frequency between the current/voltage conversion section IVC and the A/D converter 106. As a result, there is a problem that a detection speed becomes slower because of the low-pass filter LPF.

When the low-pass filter LPF having the low cutoff frequency is incorporated into a large-scale integrated (LSI) circuit to reduce a cost, there is another problem that the area becomes larger.

In order to achieve both the display and detection functions for one frame, as illustrated in FIGS. 15B and 15C, it is necessary to provide the turn-off switch element 110 and the turn-off switch control line 111 for each pixel so that there is a problem that the number of elements included in each pixel and the number of wirings are increased. As a result, the pixel size is enlarged and the degree of definition is lowered.

The present invention has been made to solve the problems of the conventional technologies described above. It is an object of the present invention to provide a image display device realizing high definition and high image quality.

The above and other objects and novel features of the present invention become apparent from the description of this specification and the accompanying drawings.

Among aspects of the invention disclosed in this application, the representative ones are briefly described as follows. (1) An image display device includes a plurality of pixels. Each of the plurality of pixels includes a self light-emitting element and a driving transistor configured to drive the self light-emitting element based on an inputted image voltage. The image display device also includes a current source configured to supply a constant current to the driving transistor and a detection section connected to a source electrode of a driving transistor of each of the plurality of pixels. The current source is connected to the source electrode of the driving transistor. The detection section detects a source voltage of the driving transistor to which the constant current is supplied during a detection period. (2) In the image display device according to item (1) , the driving transistor operates in a saturation region. A threshold voltage of the driving transistor is detected based on the detected source voltage of the driving transistor. (3) In the image display device according to item (2), the constant current includes constant currents (Id1 and Id2). In a state that a control voltage of a control electrode of the driving transistor is set to a voltage (Vg), the detection section detects a source voltage (V1) of the driving transistor in a case where the constant current (Id1) is supplied to the driving transistor and a source voltage (V2) of the driving transistor in a case where the constant current (Id2) is supplied to the driving transistor of at least one of the plurality of pixels. The detection section detects the threshold voltage of the driving transistor based on the detected source voltage (V1), the detected source voltage (V2), and the voltage (Vg).

(4) In the image display device according to item (2), the constant current includes constant currents (Id1 and Id2), one of two adjacent pixels is set as a first pixel, and the other is set as a second pixel. In a state that a control voltage of a control electrode of the driving transistor is set to a voltage (Vg), the detection section detects a source voltage (V11) of the driving transistor of the first pixel in a case where the constant current (Id1) is supplied to the driving transistor of the first pixel, a source voltage (V21) of the driving transistor of the second pixel in a case where the constant current (Td1) is supplied to the driving transistor of the second pixel, a source voltage (V12) of the driving transistor of the first pixel in a case where the constant current (Id2) is supplied to the driving transistor of the first pixel, and a source voltage (V22) of the driving transistor of the second pixel in a case where the constant current (Id2) is supplied to the driving transistor of the second pixel. The detection section detects a difference voltage between the threshold voltage of the driving transistor of the first pixel and the threshold voltage of the driving transistor of the second pixel based on the detected source voltage (V11), the detected source voltage (V21), the detected source voltage (V12), and the detected source voltage (V22). (5) In the image display device according to item (3) or (4), the constant current (Id1) and the constant current (Id2) are set such that √(Id1/Id2) is a multiple of 2. (6) In the image display device according to item (1), the driving transistor operates in a linear region. The detection section detects an anode voltage of the self light-emitting element.

A benefit obtained by the representative aspects of the invention disclosed in this application is briefly described as follows.

According to the present invention, the image display device realizes high definition and high image quality.

### BRIEF DESCRIPTION OF THE DRAWINGS

FIGS. 1A, 1B, 1C, and 1D are explanatory diagrams illustrating a fundamental pixel of the present invention.

FIGS. 2A, 2B, and 2C are explanatory diagrams illustrating an organic EL display device according to Embodiment 1 of the present invention.

FIGS. 3A and 3B are explanatory diagrams illustrating a modified example of the organic EL display device according to Embodiment 1 of the present invention.

FIG. 4 is an explanatory diagram illustrating a method of calculating a difference between threshold voltages of driving TFTs of adjacent pixels to obtain a threshold voltage of a driving TFT of each pixel.

FIG. 5A is an explanatory diagram illustrating an entire structure-A of the organic EL display device in a modified example according to Embodiment 1 of the present invention.

FIG. 5B is an explanatory diagram illustrating an entire structure-B of the organic EL display device in the modified example according to Embodiment 1 of the present invention.

FIG. 6A is an explanatory time chart illustrating an operation of the organic EL display device illustrated in FIG. 5A.

FIG. 6B is an explanatory time chart illustrating an operation of the organic EL display device illustrated in FIG. 5B.

FIGS. 7A and 7B are explanatory diagrams illustrating an organic EL display device according to Embodiment 2 of the present invention.

FIG. 8 is an explanatory diagram illustrating a gate-source voltage of a driving TFT illustrated in FIGS. 7A and 7B.

FIGS. 9A and 9B are explanatory diagrams illustrating a modified example of the organic EL display device according to Embodiment 2 of the present invention.

FIG. 10 is an explanatory diagram illustrating an entire structure of the organic EL display device in a modified example according to Embodiment 2 of the present invention.

FIG. 11 is an explanatory time chart illustrating an operation of the organic EL display device illustrated in FIG. 10.

FIG. 12A is a circuit diagram illustrating an example of an equivalent circuit of a pixel of a conventional organic EL display device.

FIG. 12B is an explanatory diagram illustrating an operation of the pixel illustrated in FIG. 12A.

FIG. 13A is a circuit diagram illustrating another example of the equivalent circuit of the pixel of the conventional organic EL display device.

FIG. 13B is an explanatory diagram illustrating an operation of the pixel illustrated in FIG. 13A.

FIGS. 14A and 14B are explanatory diagrams illustrating problems with the pixel illustrated in FIG. 12A and the pixel illustrated in FIG. 13A.

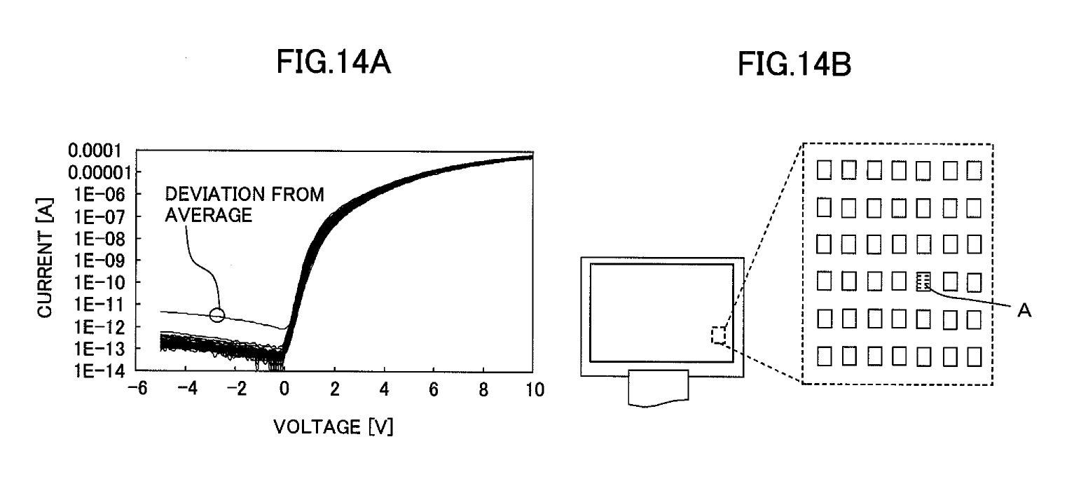

FIGS. 15A and 15B illustrate a schematic structure of the conventional organic EL display device.

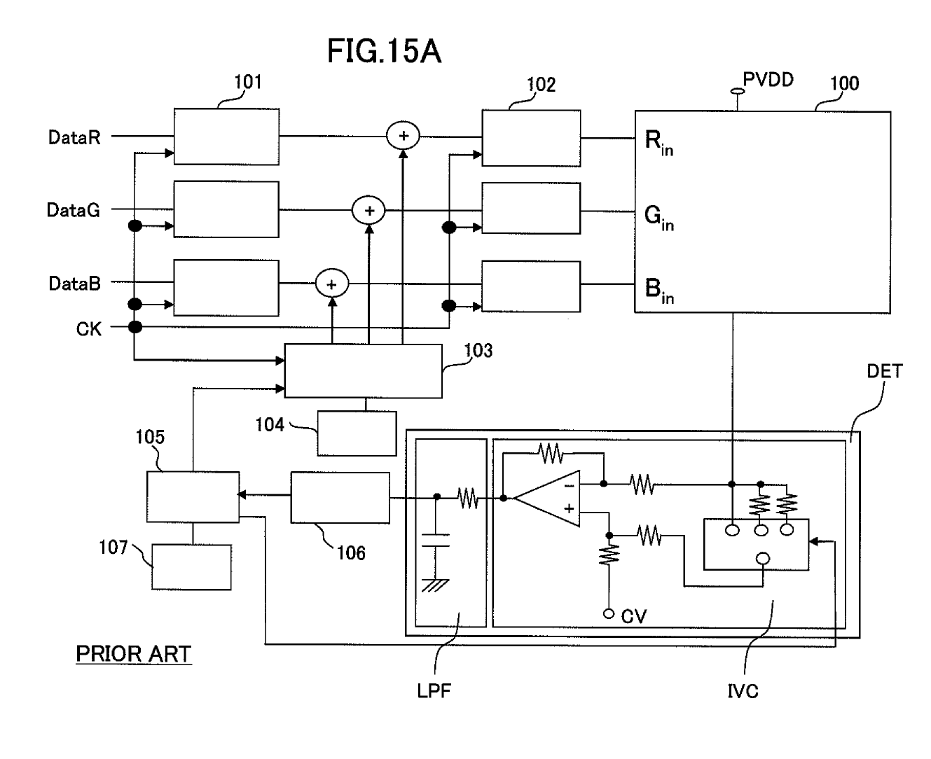

FIG. 15C illustrates a pixel circuit in the schematic structure of the conventional organic EL display device.

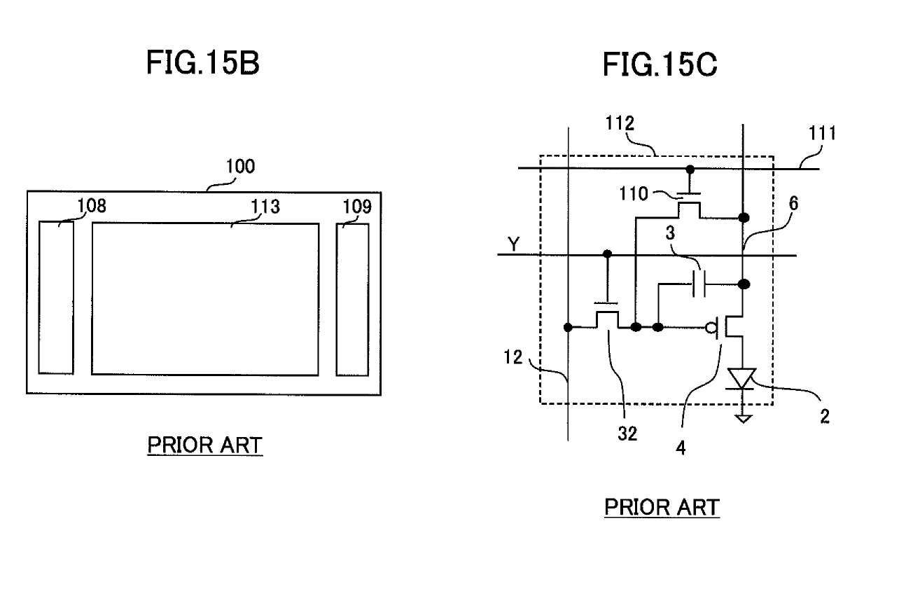

FIGS. 16A and 16B illustrate an image display device in which the organic EL display device according to any one of the embodiments of the present invention is used.

FIGS. 17A and 17B illustrate an image display device in which the organic EL display device according to any one of the embodiments of the present invention is used.

### DETAILED DESCRIPTION OF THE INVENTION

Hereinafter, embodiments of the present invention are described in detail with reference to the attached drawings.

In the explanatory drawings for the embodiments, elements having the same functions are indicated by the same reference symbols and the duplicated description thereof is omitted.

### [Equivalent Circuit of Fundamental Pixel of the Invention]

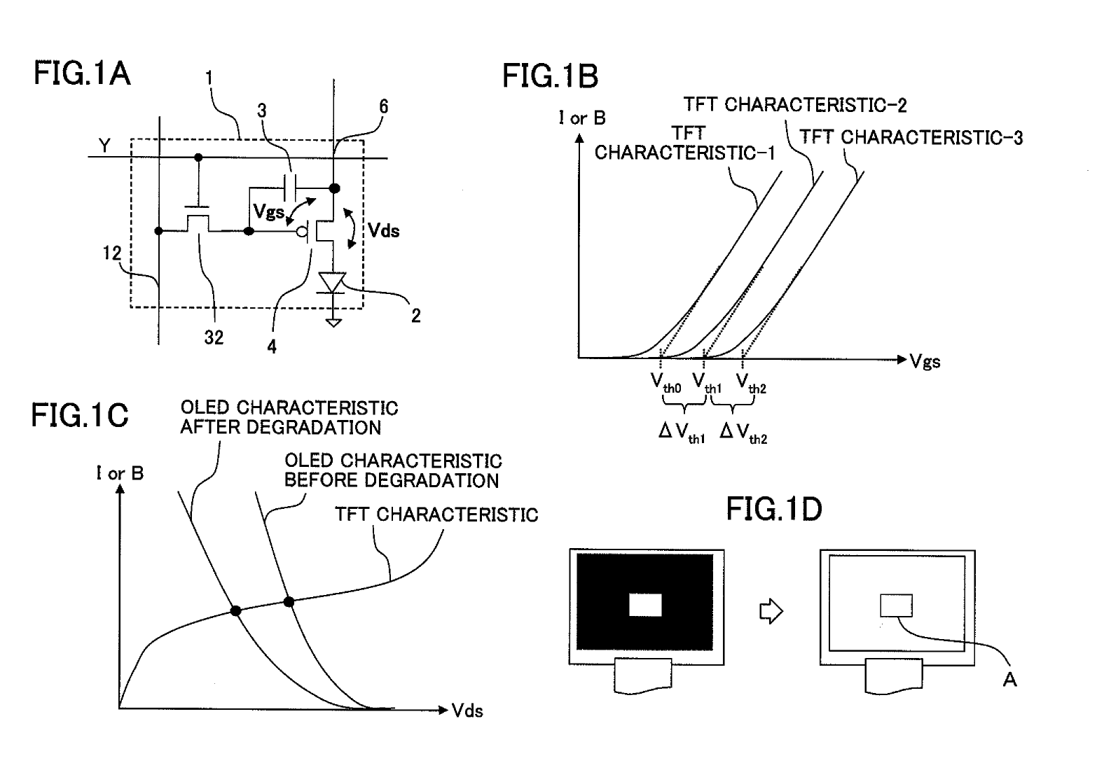

FIGS. 1A to 1D are explanatory diagrams illustrating a fundamental pixel of the present invention.

FIG. 1A is a circuit diagram illustrating an equivalent circuit of the pixel, which is a precondition of the present invention. FIG. 1A illustrates the pixel in the most common voltage program system.

A signal line 12, a selection switch line Y, and a power supply line 6 are led to a pixel 1 illustrated in FIG. 1A.

The pixel 1 includes an organic electroluminescence element (hereinafter referred to as an organic EL element) 2 serving as a light emitting element as inputs.

A cathode electrode of the organic EL element 2 is connected to a common ground line, and an anode electrode of the organic EL element 2 is connected to the power supply line 6 through a p-type thin film transistor (hereinafter referred to as a driving TFT) 4.

A holding capacitor element 3 is connected between a gate electrode and a source electrode of the driving TFT 4. The gate electrode of the driving TFT 4 is connected to the signal line 12 through a selection switch element 32 including an n-type thin film transistor.

A gate electrode of the selection switch element 32 is connected to the selection switch line Y.

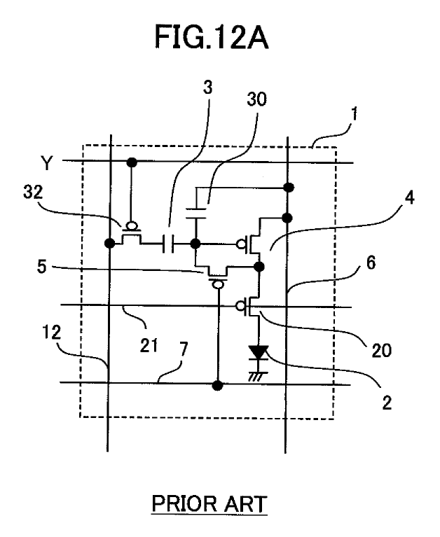

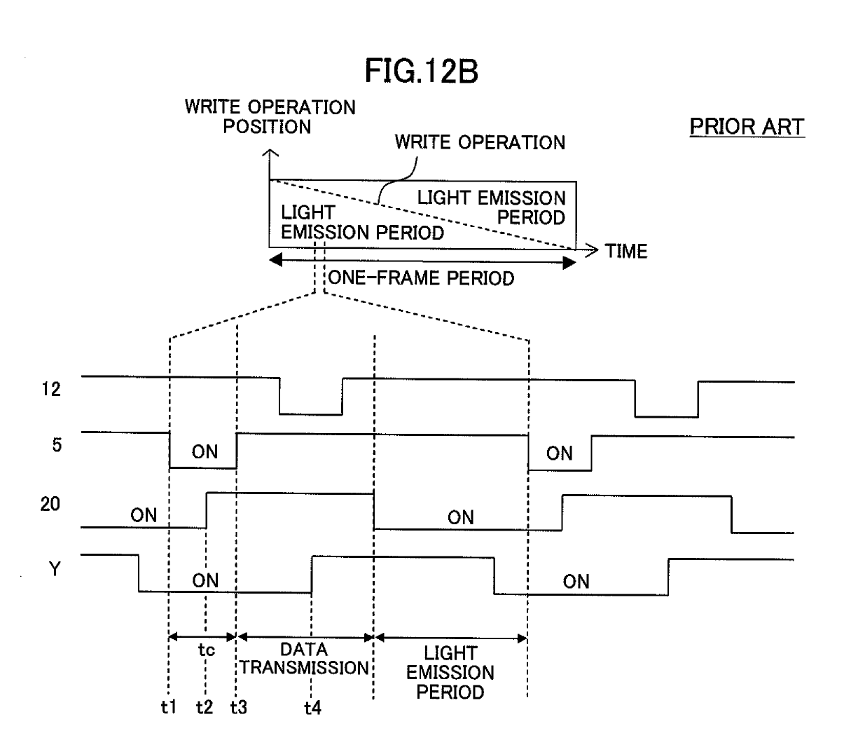

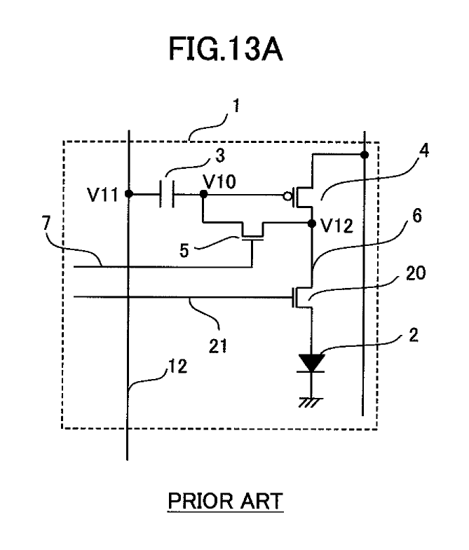

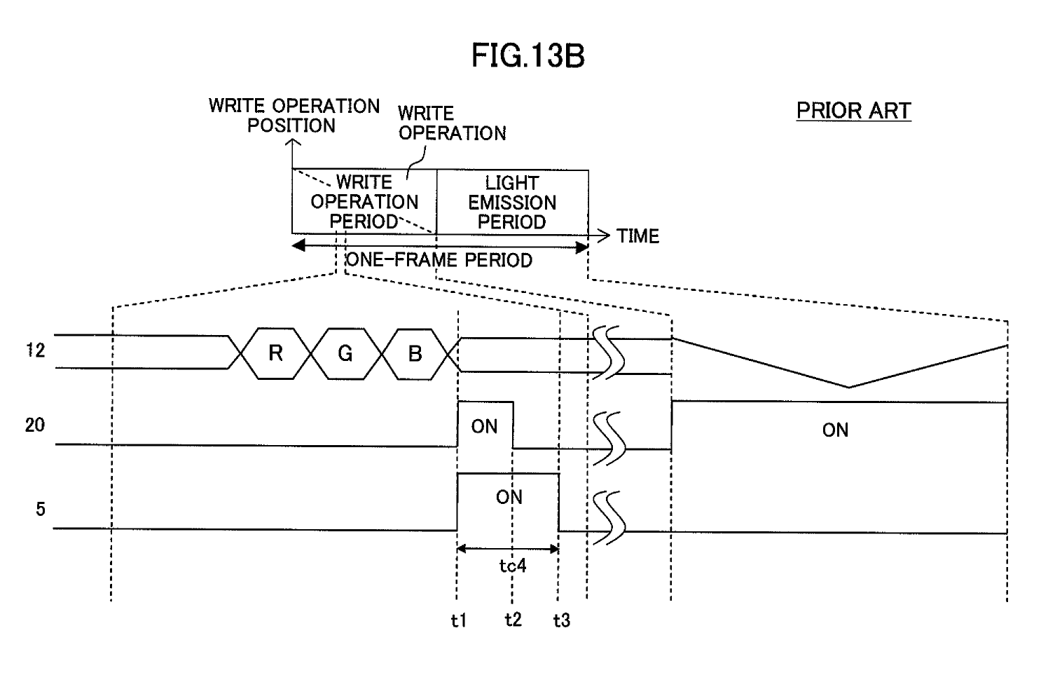

Unlike the pixels illustrated in FIGS. 12A and 13A, the pixel illustrated in FIG. 1A does not have a function for suppressing a fluctuation in threshold voltage Vth of the driving TFT 4.

Therefore, as illustrated in FIG. 1B, a difference between the threshold voltages Vth of the driving TFT 4 is reflected on a current flowing through the organic EL element 2 so that the fluctuation in threshold voltages Vth of the driving TFT 4 directly affects the luminance of the organic EL element 2.

When the characteristic of the organic EL element 2 is degraded as illustrated in FIG. 1C, an operating point thereof is shifted so that the degraded region appears as burn-in indicated by “A” as illustrated in FIG. 1D.

### Embodiment 1

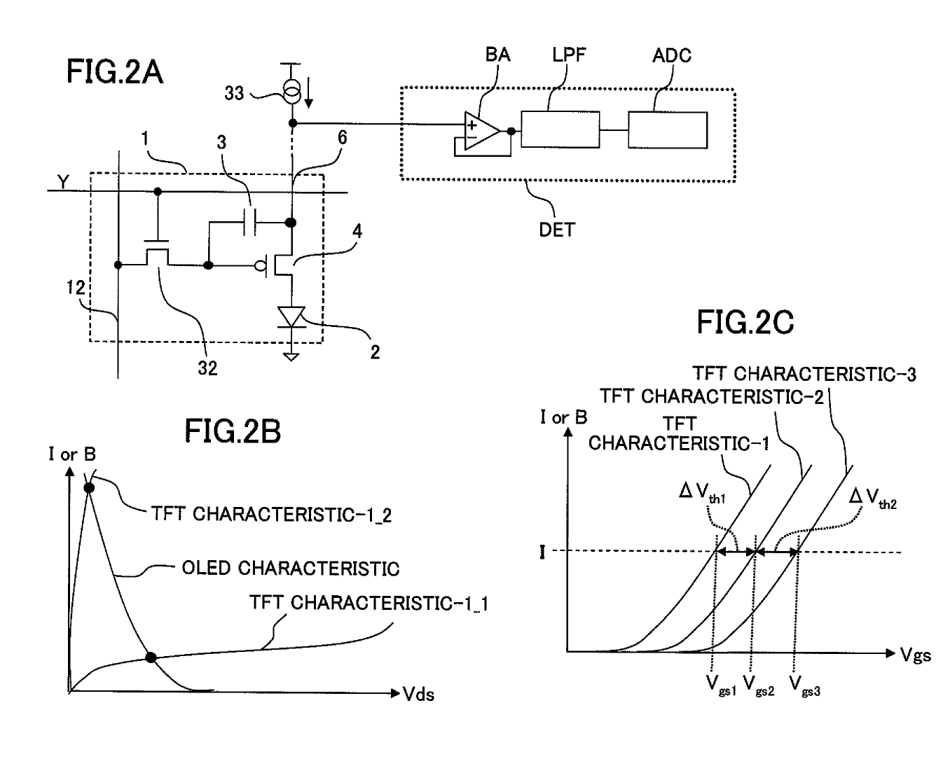

FIGS. 2A to 2C are explanatory diagrams illustrating an organic EL display device according to Embodiment 1 of the present invention.

FIG. 2A illustrates a schematic structure of the organic EL display device according to Embodiment 1 of the present invention. A large number of the pixels 1 are actually provided in a display region of an organic EL display panel, but only one pixel is illustrated in FIG. 2A.

In this embodiment, as illustrated in FIG. 2A, the power supply line 6 is connected to a current source 33. During a detection period, a constant current is supplied from the current source 33 to the pixel 1. At this time, a voltage of the source electrode of the driving TFT 4 (hereinafter also referred to as a source voltage) is detected by a detection section DET to calculate the threshold voltage Vth of the driving TFT 4.

The detection section DET includes a buffer circuit BA, a low-pass filter LPF, and an A/D converter ADC.

In this embodiment, when the selection switch element 32 is turned on to apply a gate voltage from the signal line 12 to the gate electrode of the driving TFT 4, the voltage of the source electrode of the driving TFT 4 is detected.

When a source-drain voltage Vds of the driving TFT 4 can be sufficiently ensured with respect to an overdrive voltage that is obtained by subtracting an absolute value of the threshold voltage Vth of the driving TFT 4 from the voltage supplied to the signal line 12, the driving TFT 4 maintains a saturation region.

In this case, a TFT characteristic of the driving TFT 4 becomes a TFT chracteristic-1_1 illustrated in FIG. 2B. Therefore, as illustrated in FIG. 2C, a gate-source voltage Vgs of the driving TFT 4 in a case where the constant current is supplied from the current source 33 to the driving TFT 4 can be obtained based on the detected voltage (source voltage) and the voltage (gate voltage) supplied to the signal line 12.

Because the gate-source voltage Vgs corresponds to the fluctuation in threshold voltage Vth of the driving TFT 4, the fluctuation in threshold voltage Vth of the driving TFT 4 can be calculated based on the detected voltage.

When the source-drain voltage Vds of the driving TFT 4 is not sufficiently ensured with respect to the overdrive voltage that is obtained by subtracting the absolute value of the threshold voltage Vth of the driving TFT 4 from the voltage supplied to the signal line 12, the driving TFT 4 operates in a linear region.

In this case, the TFT characteristic of the driving TFT 4 becomes a TFT chracteristic-1_2 illustrated in FIG. 2B. Therefore, the driving TFT 4 serves as an analog switch so that an anode voltage of the organic EL element 2 can be monitored when the constant current is supplied from the current source 33 to the organic EL element 2.

Thus, because a change over time of the organic EL element 2 and the like can be monitored, the burn-in indicated by A as illustrated in FIG. 1D may be determined.

When the detection operation is executed while maintaining the saturation region of the driving TFT, a detection path is connected to the source electrode of the driving TFT 4. Hence, an impedance of the detection path is low, a detection speed is high, and the detection path is a low-noise path.

In this case, a cutoff frequency of the low-pass filter LPF illustrated in FIG. 2A can be set in a wide band. Therefore, when the detection path is provided as an LSI circuit, an area for a resistor R and a capacitor element C that constitute the low-pass filter LPF can be smaller, which leads to cost reduction.

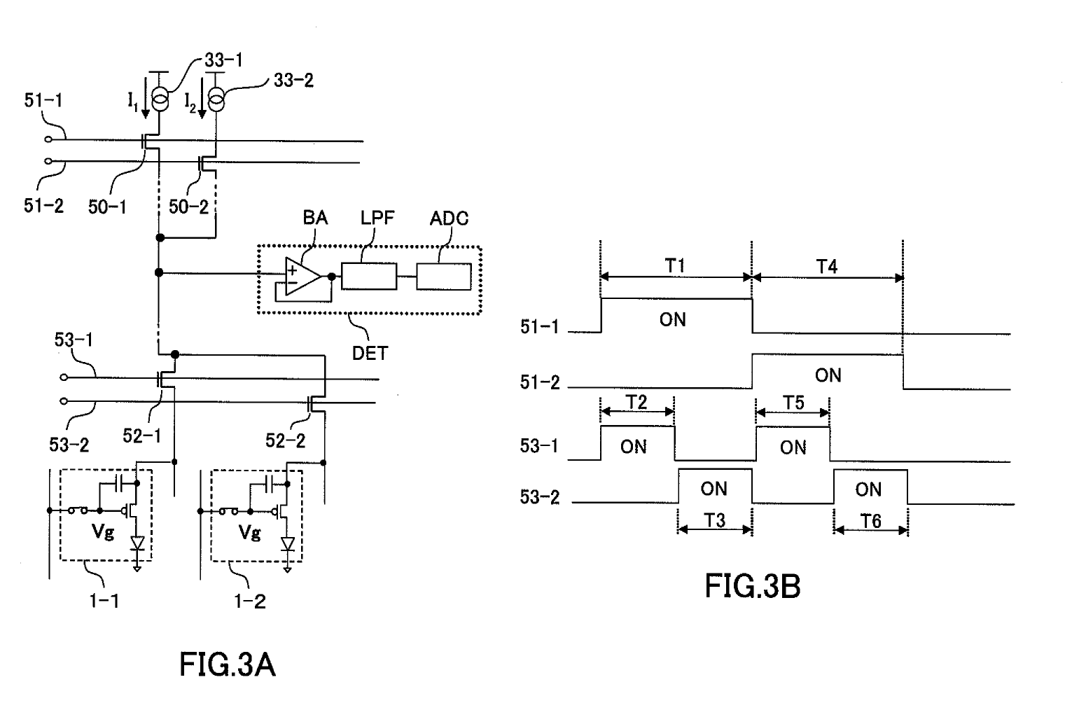

FIGS. 3A and 3B are explanatory diagrams illustrating a modified example of the organic EL display device according to Embodiment 1 of the present invention.

In the modified example illustrated in FIGS. 3A and 3B, two current sources 33-1 and 33-2 connected to the respective power supply lines 6 are prepared. A constant current supplied to pixels 1-1 and 1-2 is switched between a constant current from the current source 33-1 and a constant current from the current source 33-2 by current source selection switch elements 50-1 and 50-2 each including an n-type thin film transistor. The power supply line 6 to be supplied with the constant current from one of the current sources 33-1 and 33-2 is selected to select a pixel column by pixel selection switch elements 52-1 and 52-2 each including an n-type thin film transistor.

Gate electrodes of the current source selection switch elements 50-1 and 50-2 are connected to current source selection lines 51-1 and 51-2 respectively. Gate electrodes of the pixel selection switch elements 52-1 and 52-2 are connected to pixel selection lines 53-1 and 53-2 respectively.

When the driving TFT 4 is operated in the saturation region, Ioled indicates a current value of a current source, and V* indicates the source voltage of the driving TFT 4 that is detected by the detection section DET (hereinafter simply referred to as a detected voltage V*). In this case, the current value of the current source can be expressed by Expression (1) as described below.

Ioled=(1/2)·μ·Cox·(W/L)·(V*−Vg−(−Vth))² (1)

The detected voltage V* can be modified as expressed by Expression (2) described below.

V*=Vg−Vth−√[2·Ioled·(1/{μ·Cox·(W/L)}] (2)

In Expression (2), because the factors of fluctuation are the threshold voltage Vth and the mobility μ, and the fluctuation in mobility is also included, the detected voltage includes an effect of the fluctuation in mobility, which prevents detecting precisely.

Therefore, as illustrated in FIG. 3A, the source voltage of the driving TFT 4 is detected while the current value of the current source 33-1 and the current value of the current source 33-2 are set to “Ioled1” and “Ioled2” respectively, and the gate voltage of the driving TFT 4 is set to “Vg.”.

In a pixel in which Vth1 and μ1 indicate a threshold voltage and a mobility respectively, when V11 indicates a detected voltage in a case where the current value Ioled1 of the current source 33-1 is used, the detected voltage V11 can be expressed by Expression (3) described below. Similarly, when V12 indicates a detected voltage in a case where the current value Ioled2 of the current source 33-2 is used, the detected voltage V12 can be expressed by Expression (4) described below.

V11=Vg−Vth1−√[2·Ioled1(1/{μ1·Cox·(W/L)})] (3)

V12=Vg−Vth1−√[2·Ioled2·(1/{μ1·Cox·(W/L)})] (4)

When Expressions (3) and (4) are solved using K=√(Ioled1/Ioled2), Expression (5) described below is obtained.

Vth1={(V11−Vg)−K·(V12−Vg)}/(K−1) (5)

Similarly, in a pixel in which Vth2 and μ2 indicate a threshold voltage and a mobility respectively, when V21 indicates a detected voltage in the case where the current value Ioled1 of the current source 33-1 is used, the detected voltage V21 can be expressed by Expression (6) described below. Similarly, when V22 indicates a detected voltage in the case where the current value Ioled2 of the current source 33-2 is used, the detected voltage V22 can be expressed by Expression (7) described below.

When the threshold voltage Vth2 is obtained based on Expressions (6) and (7), the threshold voltage Vth2 is expressed by Expression (8) described below.

V21=Vg−Vth2−√[2−Ioled1·(1/{μ2·Cox·(W/L)})] (6)

V22=Vg−Vth2−√[2·Ioled2·(1/{μ2·Cox·(W/L)})] (7)

Vth2={(V21−Vg)−K·(V22−Vg)}/(K−1) (8)

As understood from Expressions (5) and (8), by setting the two kinds of current sources, the threshold voltage Vth can be detected without being affected by the fluctuation in mobility.

Expression (9) described below is obtained based on Expressions (5) to (8).

Vth1−Vth2={K·(V22−V12)−(V21−V11)}/(K−1) (9)

As described above, the threshold voltage Vth of the driving TFT 4 can be detected based on the detected voltage, the gate voltage Vg of the driving TFT 4, and the current ratio between the current value Ioled1 of the current source 33-1 and the current value Ioled2 of the current source 33-2.

When (Ioled1/Ioled2)=4, K=2.Thus, Expressions (5) and (8) described above are converted to Expressions (10) and (11).

Vth1={(V11−Vg)−2·(V12−Vg)} (10)

Vth2={(V21−Vg)−2·(V22−Vg)} (11)

When a difference voltage between the threshold voltages Vth of the driving TFTs 4 of adjacent pixels is obtained, the fluctuation in threshold voltages Vth can be detected based on the detected voltage and the current ratio between the current value Ioled1 of the current source 33-1 and the current value Ioled2 of the current source 33-2.

When (Ioled1/Ioled2)=4, K=2. Thus, Expression (9) described above is converted to Expression (12).

Vth1−Vth2=(2V22−V21)−(2V12−V11) (12)

When the respective detected values of V11, V12, V21, and V22 are A/D-converted, digital values of “2V12” and “2V22” can be obtained by simple calculation such as one-bit shifting of the digital values of the respective detected values of V12 and V22 obtained through the A/D-conversion.

Therefore, difference voltage information between the threshold voltages Vth1 and Vth2 can be obtained by the simple calculation.

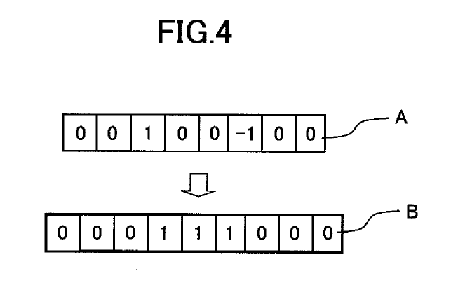

Assume that the difference voltage information between the threshold voltages Vth1 and Vth2 of the adjacent pixels is in a state indicated by A illustrated in FIG. 4.

In the state indicated by A illustrated in FIG. 4, when difference values with respect to the threshold voltage Vth of the driving TFT 4 of a pixel located on the leftmost side are added, a difference between the threshold voltage Vth of the driving TFT 4 of each pixel and the reference threshold voltage Vth can be obtained as indicated by B illustrated in FIG. 4.

The threshold voltages Vth of the driving TFTs 4 of the respective pixels are corrected with respect to a minimum threshold voltage Vth in the state indicated by “B” illustrated in FIG. 4 so that the threshold voltages Vth of the driving TFTs 4 of the respective pixels can be equal to one another.

FIG. 3B is a time chart for realizing the operation described above.

During a period T1 of FIG. 3B, the current source selection line 51-1 becomes in the High level (hereinafter simply referred to as “H-level”), and the current source selection line 51-2 becomes in the Low level (hereinafter simply referred to as “L-level”). Hence, the current source selection switch element 50-1 is turned on, and the current source selection switch element 50-2 is turned off.

During a period T2 within the period T1, the pixel selection line 53-1 becomes in the H-level, and the pixel selection line 53-2 becomes in the L-level. Thus, the pixel selection switch element 52-1 is turned on, and the pixel selection switch element 52-2 is turned off. Therefore, during the period T2, the source voltage V11 of the driving TFT 4 of the pixel 1-1 in the case where the current value Ioled1 of the current source 33-1 is used can be detected.

During a period T3 within the period T1, the pixel selection line 53-1 becomes in the L-level, and the pixel selection line 53-2 becomes in the H-level. Thus, the pixel selection switch element 52-1 is turned off, and the pixel selection switch element 52-2 is turned on. Therefore, during the period T3, the source voltage V21 of the driving TFT 4 of the pixel 1-2 in the case where the current value Ioled1 of the current source 33-1 is used can be detected.

During a period T4 of FIG. 3B, the current source selection line 51-1 becomes in the L-level, and the current source selection line 51-2 becomes in the H-level. Thus, the current source selection switch element 50-1 is turned off, and the current source selection switch element 50-2 is turned on.

During a period T5 within the period T4, the pixel selection line 53-1 becomes in the H-level and the pixel selection line 53-2 becomes in the L-level. Thus, the pixel selection switch element 52-1 is turned on and the pixel selection switch element 52-2 is turned off. Therefore, during the period T5, the source voltage V12 of the driving TFT 4 of the pixel 1-1 in the case where the current value Ioled2 of the current source 33-2 is used can be detected.

During a period T6 within the period T4, the pixel selection line 53-1 becomes in the L-level, and the pixel selection line 53-2 becomes in the H-level. Thus, the pixel selection switch element 52-1 is turned off, and the pixel selection switch element 52-2 is turned on. Therefore, during the period T6, the source voltage V22 of the driving TFT 4 of the pixel 1-2 in the case where the current value Ioled2 of the current source 33-2 is used can be detected.

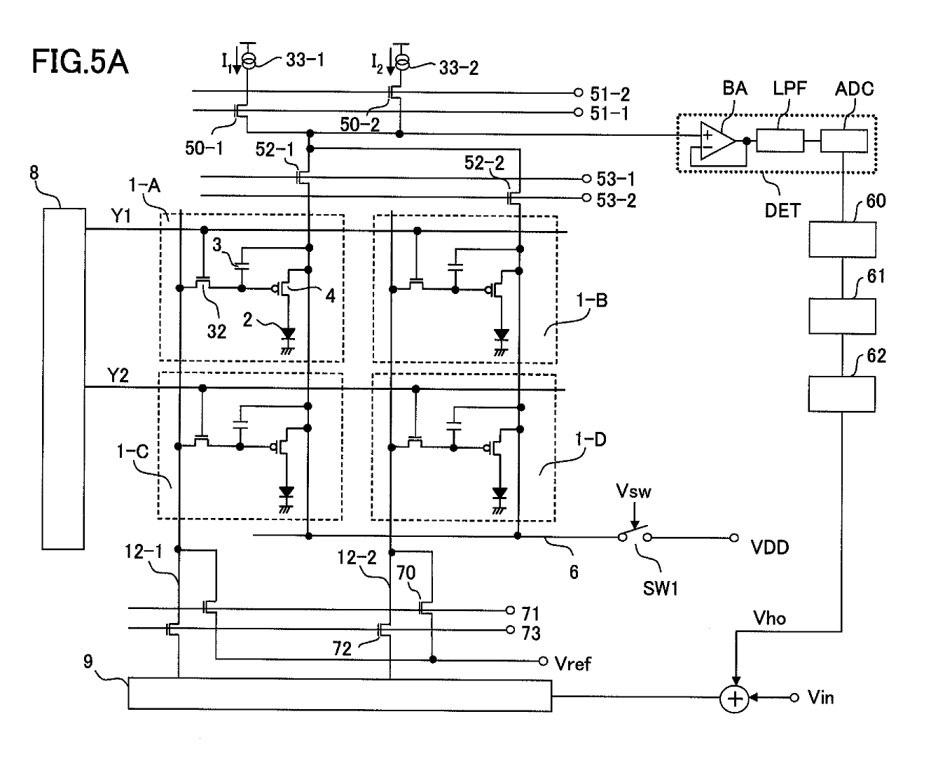

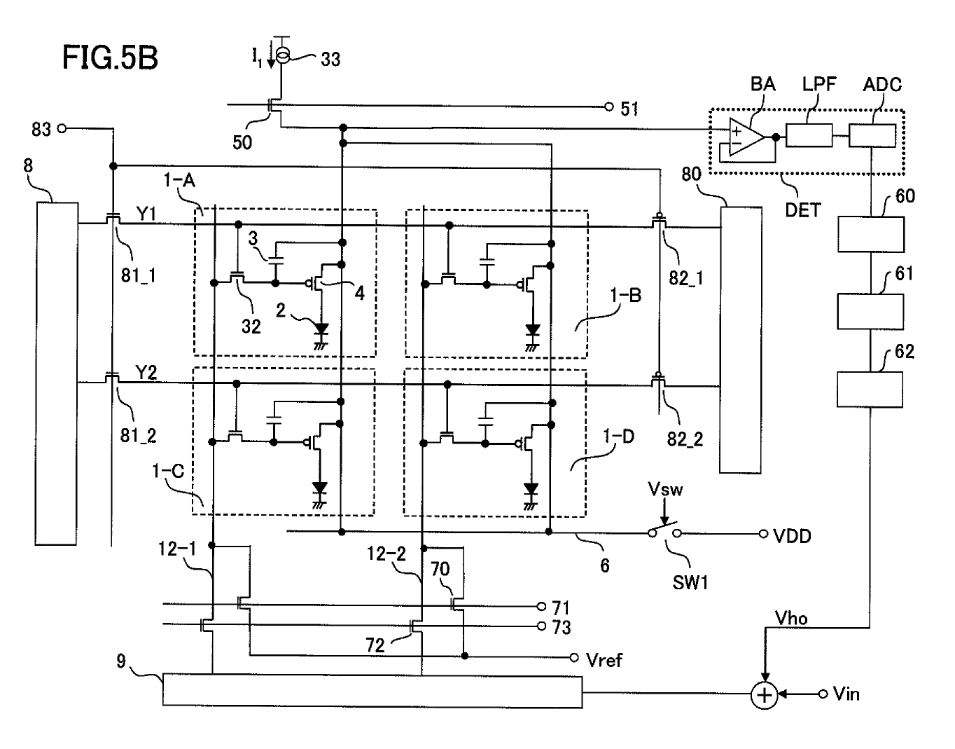

FIGS. 5A and 5B are explanatory diagrams illustrating the entire structures of the organic EL display device in the modified example according to Embodiment 1 of the present invention.

In FIG. 5A, reference voltage selection switch elements 70 for supplying a reference voltage Vref to signal lines 12-1 and 12-2 and signal line selection switch elements 72 for supplying image voltages from a signal line driver circuit 9 to the signal lines 12-1 and 12-2 are provided in the circuit structure illustrated in FIG. 3A. Gate electrodes of the reference voltage selection switch elements 70 are connected to a reference voltage selection line 71. Gate electrodes of the signal line selection switch elements 72 are connected to a signal line selection line 73.

A voltage VDD for display through a switch element SW1 is supplied to the respective power supply lines 6 during a display period in which the detection operation is not performed. The switch element SW1 is controlled through a power supply control line Vsw. As illustrated in FIG. 5A, selection switch lines Y1 and Y2 are connected to a scan line driver circuit 8.

The digital values (digital values obtained by A/D-converting detected voltages V11, V12, V21, and V22) output from the A/D converter ADC of the detection section DET are input to a calculation section 60. The calculation section 60 calculates the threshold voltage Vth or a difference voltage between threshold voltages Vth of adjacent pixels based on the input detected voltages. Information indicating the calculated threshold voltage or difference voltage is stored in a memory 61. A correction signal generation section 62 generates correction data Vho based on the information stored in the memory 61. The correction data Vho output from the correction signal generation section 62 is added to input display data Vin.

In FIG. 5B, in the structure illustrated in FIG. 5A, selection switches 81_1 and 81_2 are provided between the selection switch lines Y1 and Y2 and the scan line driver circuit 8. Selection switches 82_1 and 82_2 are provided between the selection switch lines Y1 and Y2 and a pixel row selection circuit 80. In order to turn on one of a group including the selection switches 81_1 and 81_2 and a group including the selection switches 82_1 and 82_2, gate electrodes of the selection switches 81_1, 81_2, 82_1, and 82_2 are connected to a selection circuit control line 83.

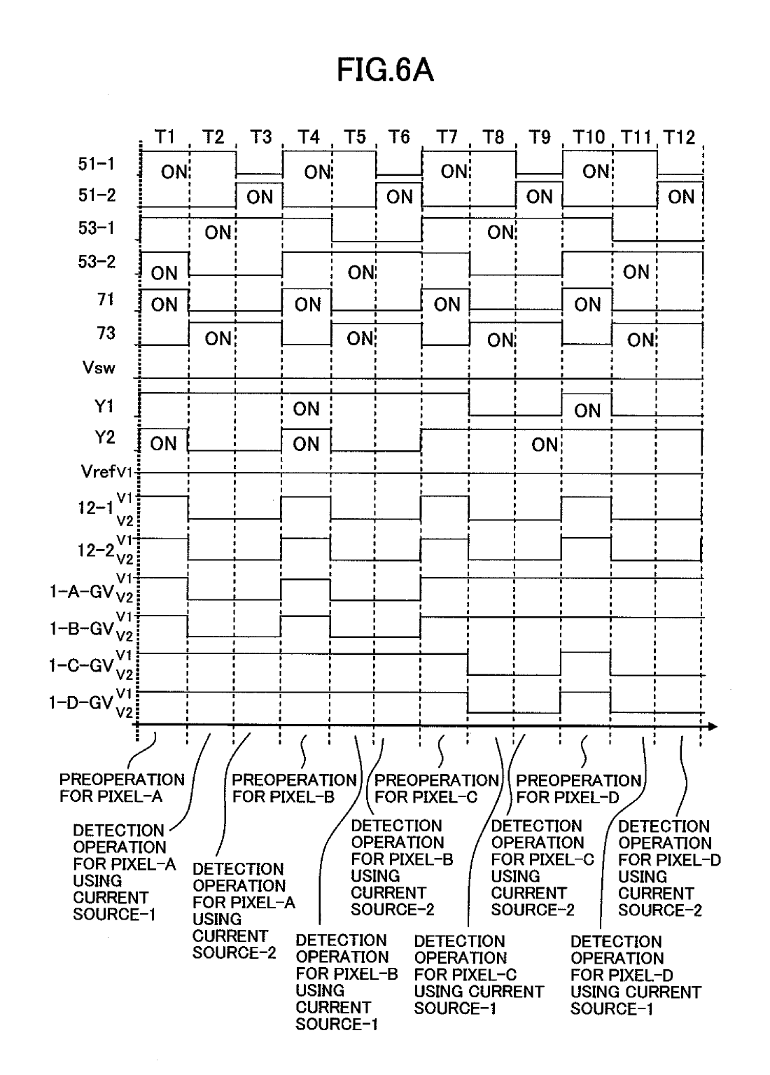

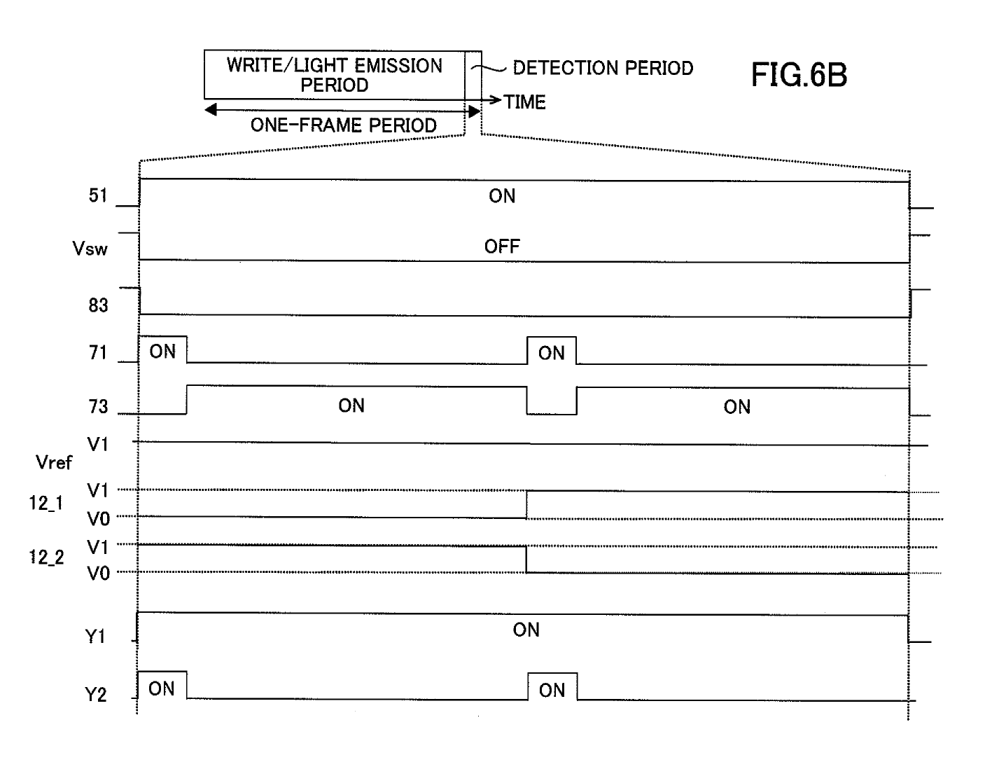

FIG. 6A is an explanatory time chart illustrating the operation of the organic EL display device illustrated in FIG. 5A.

As illustrated in FIG. 5A, an actual organic EL display panel includes the plurality of pixels arranged in matrix in the lateral direction and the longitudinal direction. Therefore, as illustrated in the time chart of FIG. 6A, preoperation is introduced before each detection operation.

During a period T1 (preoperation of pixel 1-A), a scan voltage of the H-level is supplied to each of the selection switch lines Y1 and Y2, so that the selection switch element 32 of each of pixels 1-A, 1-B, 1-C, and 1-D is turned on.

Also, during the period T1, the current source selection line 51-1 becomes in the H-level, and the current source selection line 51-2 becomes in the L-level. Hence, the current source selection switch element 50-1 is turned on, and the current source selection switch element 50-2 is turned off. Both the pixel selection lines 53-1 and 53-2 become in the H-level so that both the pixel selection switch elements 52-1 and 52-2 are turned on.

Therefore, during the period T1, for example, the constant current Ioled1 is supplied from the current source 33-1 to all the power supply lines 6.

Further, during the period T1, the reference voltage selection line 71 becomes in the H-level, and the signal line selection line 73 becomes in the L-level. Hence, the reference voltage selection switch elements 70 are turned on, and the signal line selection switch elements 72 are turned off. Moreover, a control voltage V1 is supplied as the reference voltage Vref so that the control voltage V1 is supplied to the signal lines 12-1 and 12-2.

Therefore, the control voltage V1 is input to the gate electrodes of the driving TFTs 4 of the respective pixels 1-A, 1-B, 1-C, and 1-D, and the driving TFTs 4 of the respective pixels 1-A, 1-B, 1-C, and 1-D are turned off. In addition, in FIG. 6A, 1-A-GV, 1-B-GV, 1-C-GV, and 1-D-GV indicate voltages at the gate electrodes of the driving TFTs 4 of the pixels 1-A, 1-B, 1-C, and 1-D respectively.

FIG. 6B is an explanatory time chart illustrating the operation of the organic EL display device illustrated in FIG. 5B.

One frame is divided into a write/light emission period for displaying and a detection period.

During the detection period, in order to separate the voltage of the source electrode of the driving TFT 4 of each pixel from the voltage VDD for displaying and to connect the source electrode for detection, the level of the current source selection line 51 is set to the H-level to turn on the current source selection switch element 50 and the switch element (power supply control switch) SW1 is turned off through the power supply control line Vsw.

The scan line driver circuit 8 is used for displaying that includes writing and light emission, and the pixel row selection circuit 80 is used for detection. Hence, the level of the selection circuit control line 83 is switched from the H-level to the L-level, the selection switches 81_1 and 81_2 are turned off, and the selection switches 82_1 and 82_2 are turned on.

During the detection period, first, the levels of the selection switch lines Y1 and Y2 are set to the H-level so that the selection switch element 32 of each of the pixels 1-A, 1-B, 1-C, and 1-D is turned on. In such a state, by providing the H-level signal to the reference voltage selection line 71 and by providing the L-level signal to the signal line selection line 73, the control voltage V1 is input as the reference voltage Vref so as to turn off all the driving TFTs of the pixels 1-A, 1-B, 1-C, and 1-D.

Next, the level of the selection switch line Y2 is set to the L-level so that the selection switch element 32 of each of the pixels 1-A and 1-B are turned on, and the selection switch element 32 of each of the pixels 1-C and 1-D is turned off. In such a state, by providing the L-level signal to the reference voltage selection line 71 is set to the L-level and by providing the H-level signal to the signal line selection line 73, a control voltage V2 is supplied from the signal line driver circuit 9. Therefore, a control voltage V0 or V1 is supplied to the signal lines 12-1 and 12-2. When the control voltage V0 is supplied to the signal line 12-1, and the control voltage V1 is supplied to the signal line 12-2, a characteristic of the pixel 1-A is detected. When the control voltage V1 is supplied to the signal line 12-1, and the control voltage V0 is supplied to the signal line 12-2, a characteristic of the pixel 1-B is detected.

Thus, while each of the pixels has the structure including the two TFTs and the single lateral line, both the display and detection functions can be provided for one frame, and, hence, high definition can be maintained.

During a next period T2, the scan voltage of the L-level is supplied to the selection switch line Y2 so that the selection switch elements 32 of the pixels 1-C and 1-D are turned off.

During the period T2, the reference voltage selection line 71 becomes in the L-level, and the signal line selection line 73 becomes in the H-level. Hence, the reference voltage selection switch elements 70 are turned off, and the signal line selection switch elements 72 are turned on. During the period T2, the control voltage V2 is supplied from the signal line driver circuit 9 so that the control voltage V2 is supplied to the signal lines 12-1 and 12-2.

Therefore, because the gate electrode of the driving TFT 4 of each of the pixels 1-C and 1-D holds the control voltage V1 for the period T1, the driving TFT 4 of each of the pixels 1-C and I-D is turned off. On the other hand, because the control voltage V2 is input to the gate electrode of the driving TFT 4 of each of the pixels 1-A and 1-B, the driving TFT 4 of each of the pixels 1-A and 1-B is turned on.

Further, during the period T2, because the pixel selection line 53-2 becomes in the L-level, the pixel selection switch element 52-2 is turned off. Therefore, the power supply line 6 connected to the source electrode of the driving TFT 4 of each of the pixels 1-B and 1-D becomes in a floating state.

Therefore, because, during the period T2, for example, the constant current Ioled1 is supplied from the current source 33-1 to the driving TFT 4 and the organic EL element 2 in the pixel 1-A, the source voltage (V1) of the driving TFT 4 of the pixel 1-A is detected by the detection section DET.

During a next period T3, the current source selection line 51-1 is in the L-level, and the current source selection line 51-2 is in the H-level. Hence, the current source selection switch element 50-1 is turned off, and the current source selection switch element 50-2 is turned on.

Therefore, because, during the period T3, for example, the constant current Ioled2 is supplied from the current source 33-2 to the driving TFT 4 and the organic EL element 2 in the pixel 1-A, the source voltage (V2) of the driving TFT 4 of the pixel 1-A is detected by the detection section DET.

After that, during each of periods T5 and T6, while the pixel selection switch element 52-1 is turned off, and the pixel selection switch element 52-2 is turned on, the same operation as described above is performed. Thus, the source voltages (V1 and V2) of the driving TFT 4 of the pixel 1-B in the cases where the constant currents Ioled1 and Ioled2 are supplied to the driving TFT 4 and the organic EL element 2 in the pixel 1-B are detected by the detection section DET.

During each of periods T7, T8, T11, and T12, while the selection switch elements 32 of the pixels 1-A and 1-B are turned off, and the selection switch elements 32 of the pixels 1-C and 1-D are turned on, the same operation as described above is performed. Thus, the source voltages (V1 and V2) of the driving TFT 4 of each of the pixels 1-C and 1-D in the cases where the constant currents Ioled1 and Ioled2 are supplied to the driving TFT 4 and the organic EL element 2 in each of the pixels 1-C and 1-D are detected by the detection section DET.

Here, during the display period in which the detection operation is not performed, the pixel selection switch elements 52-1 and 52-2 are turned off to separate the current sources 33-1 and 33-2 from the power supply lines 6. The switch element SW1 is turned on to supply the voltage VDD for displaying to the power supply lines 6. In contrast, during the detection period, the switch element SW1 is turned off to separate the voltage VDD for displaying from the power supply lines 6.

The information of the threshold voltage Vth calculated by the calculation section 60 or the information of the difference voltage between the threshold voltages Vth of the adjacent pixels is stored in the memory 61. The correction signal generation section 62 generates the correction data Vho based on the information stored in the memory 61. The generated correction data Vho is added to the input display data Vin, and the resultant data is input to the signal line driver circuit 9.

### Embodiment 2

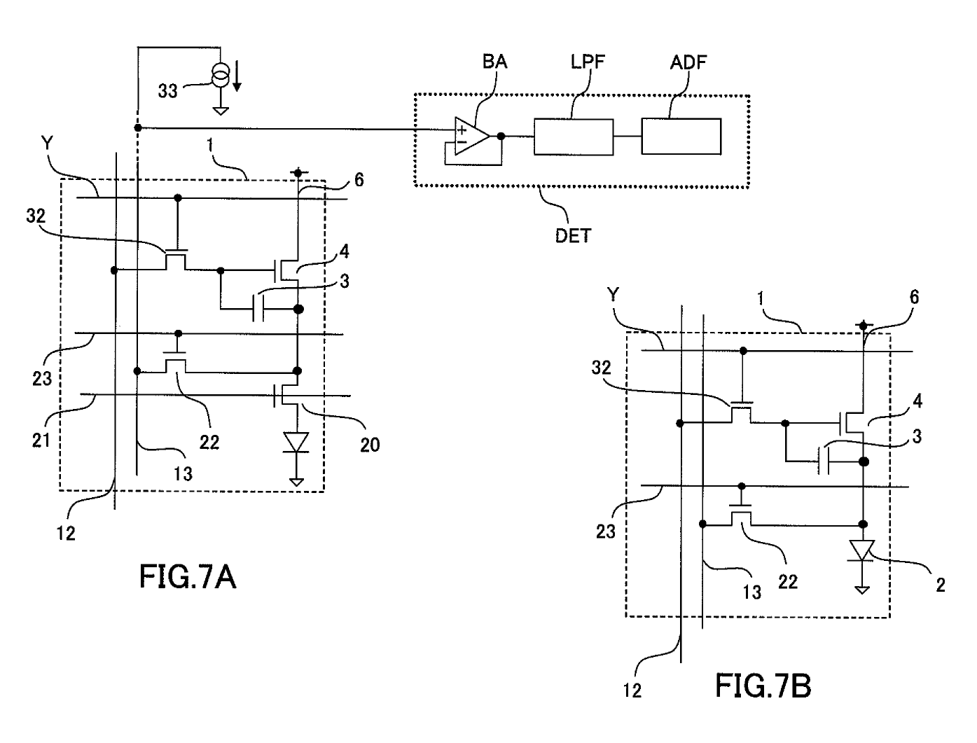

FIGS. 7A and 7B are explanatory diagrams illustrating an organic EL display device according to Embodiment 2 of the present invention.

In this embodiment, an n-type thin film transistor is used as the driving TFT 4. Therefore, in this embodiment, as illustrated in FIG. 7A, the drain electrode of the driving TFT 4 is connected to the power supply line 6, and the source electrode of the driving TFT 4 is connected to the anode electrode of the organic EL element 2 through a turn-on switch element 20.

In this embodiment, the current source 33 is connected to a current supply line 13. A detection switch element 22 is connected between the current supply line 13 and the source electrode of the driving TFT 4.

A gate electrode of the turn-on switch element 20 is connected to a turn-on switch line 21. A gate electrode of the detection switch element 22 is connected to a detection switch line 23.

In this embodiment as illustrated in FIG. 7A, when the selection switch element 32 and the detection switch element 22 are turned on, and the turn-on switch element 20 is turned off and when the control voltage (gate voltage) Vg is applied through the signal line 12 to the gate electrode of the driving TFT 4, the constant current is supplied to the driving TFT 4 through a path including the driving TFT 4, the detection switch element 22, the current supply line 13, and the current source 33, in order to detect the source voltage of the driving TFT 4.

When the detected source voltage is sufficiently low, and an anode-cathode voltage of the organic EL element 2 is sufficiently low, a current does not flow into the organic EL element 2. Therefore, as illustrated in FIG. 7B, the turn-on switch element 20 and the turn-on switch line 21 can be omitted.

Like Embodiment 1, when the source-drain voltage Vds of the driving TFT 4 can be sufficiently ensured with respect to the overdrive voltage obtained by subtracting the absolute value of the threshold voltage Vth of the driving TFT 4 from the voltage supplied to the signal line 12, the driving TFT 4 maintains the saturation region.

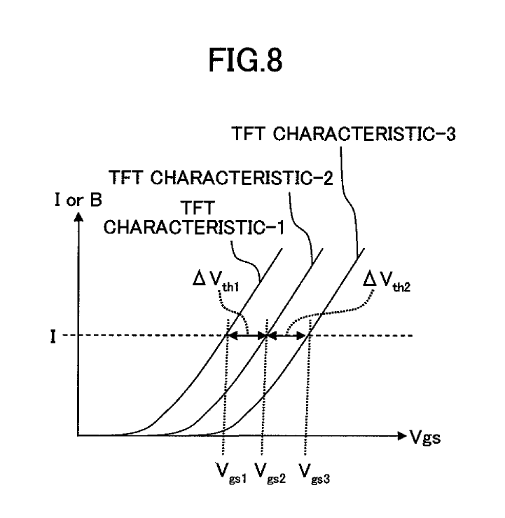

Therefore, as illustrated in FIG. 8, the gate-source voltage Vgs of the driving TFT 4 in the case where the constant current is supplied from the current source 33 to the driving TFT 4 can be obtained based on the detected voltage (source voltage) and the voltage (gate voltage) supplied to the signal line 12.

Because the gate-source voltage Vgs of the driving TFT corresponds to the fluctuation in threshold voltage Vth of the driving TFT 4, the fluctuation in threshold voltage Vth of the driving TFT 4 can be calculated based on the detected voltage.

In this embodiment, when the driving TFT 4 is operated while maintaining the saturation region to detect the source voltage of the driving TFT 4, a detection path is connected to the source electrode of the driving TFT 4, and, hence, an impedance of the detection path is low, a detection speed is high, and the detection path is a low-noise path.

Accordingly, the cutoff frequency of the low-pass filter LPF of the detection section DET can be set in a wide band. Therefore, when the detection section DET is provided as an LSI circuit, an area for the resistor R and the capacitor element C which constitute the low-pass filter LPF can be smaller, which leads to cost reduction.

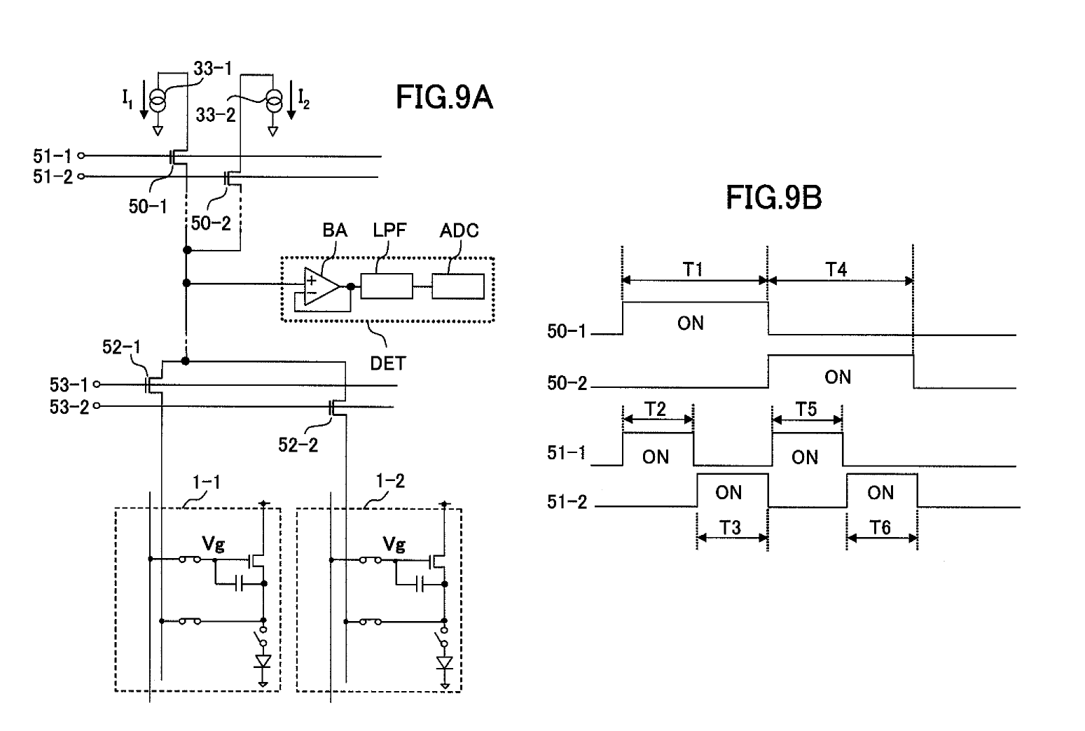

FIGS. 9A and 9B are explanatory diagrams illustrating a modified example of the organic EL display device according to Embodiment 2 of the present invention.

In the circuit structure illustrated in FIG. 9A, like Embodiment 1 described above, under the condition, (Ioled1/Ioled2)=4, the constant current value of the current source 33-1 and the constant current value of the current source 33-2 are set to “Ioled1” and “Ioled2” respectively. The gate voltage of the driving TFT 4 is set to “Vg.” In such a state, when the source voltages (V1, V2, V11, V12, V21, and V22) of the driving TFT 4 are detected in the same manner as in Embodiment 1 described above, the threshold voltage Vth of the driving TFT 4 and a difference voltage between the threshold voltages Vth of the driving TFTs 4 of adjacent pixels can be calculated.

In particular, when only the bit-shift operation of the digital values of the detected voltages is performed, the difference voltage between the threshold voltages Vth of the driving TFTs 4 of the adjacent pixels can be calculated without being affected by the fluctuation in mobility. FIG. 9B is a time chart for realizing the operation described above.

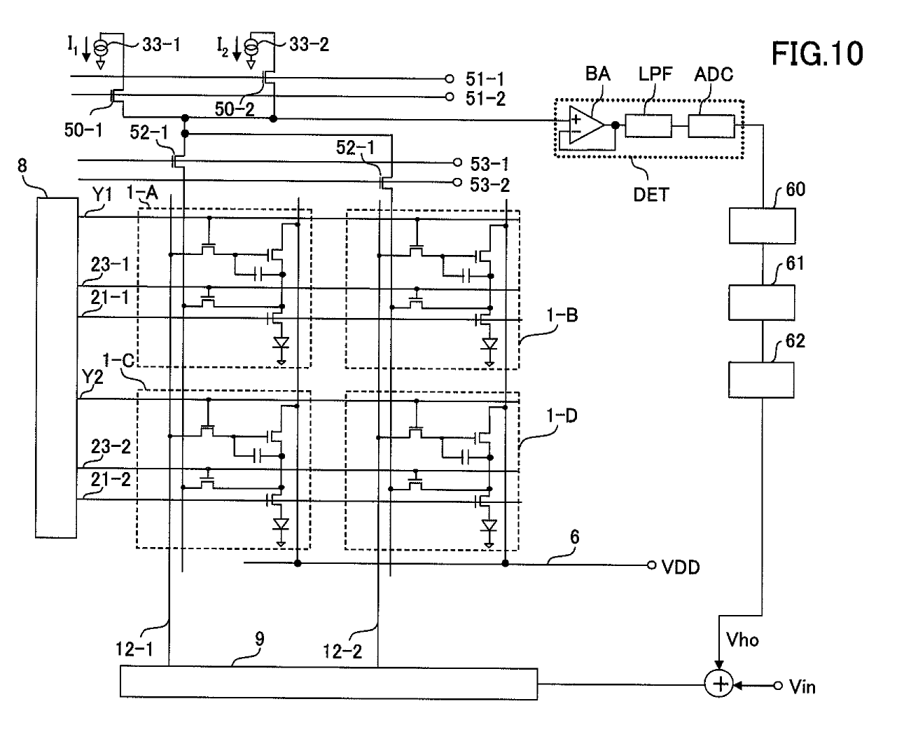

FIG. 10 is an explanatory diagram illustrating the entire structure of the organic EL display device in the modified example according to Embodiment 2 of the present invention.

The fundamental detection operation of the circuit illustrated in FIG. 10 is the same as that in Embodiment 1 described above. In Embodiment 2, the detection switch element 22 is used to select a pixel to be detected. Therefore, unlike Embodiment 1, the detection operation can be executed without the preoperation.

For all the pixels, the control voltage (Vg) is desirably applied to the gate electrode of the driving TFT 4 of each of the pixels. Therefore, this embodiment does not require the reference voltage selection switch elements 70, the reference voltage selection line 71, the signal line selection switch elements 72, and the signal line selection line 73 as illustrated in FIGS. 5A and 5B.

The circuit illustrated in FIG. 10 requires the voltage VDD for displaying for both the detection operation and the display operation performed during the display period in which the detection operation is not performed, and, hence, the voltage VDD is continuously supplied.

During the display period in which the detection operation is not performed, the pixel selection switch elements 52-1 and 52-2 are turned off to separate the current sources 33-1 and 33-2 from the power supply lines 6.

In this embodiment, while the selection switch element 32 and the turn-on switch element 20 are turned on, a light emission operating point of the organic EL element 2 is determined. In other words, the driving TFT 4 operates as a source follower circuit to turn on the organic EL element 2.

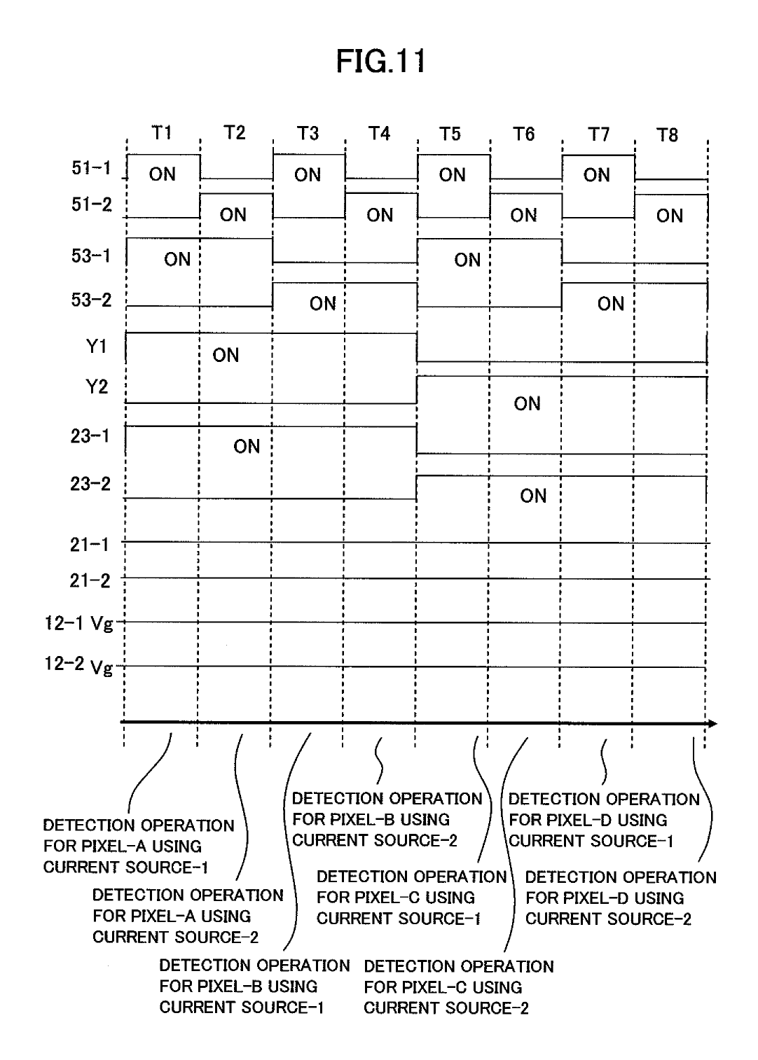

FIG. 11 is an explanatory time chart illustrating the operation of the organic EL display device illustrated in FIG. 10.

During a detection period T1, a scan voltage of the H-level is supplied to the selection switch line Y1, and a scan voltage of the L-level is supplied to the selection switch line Y2. Hence, the selection switch element 32 of each of the pixels 1-A and 1-B is turned on, and the selection switch element 32 of each of the pixels 1-C and 1-D is turned off.

During this period, a detection switch line 23-1 becomes in the H-level and a detection switch line 23-2 becomes in the L-level. Hence, the detection switch element 22 of each of the pixels 1-A and 1-B is turned on, and detection switch element 22 of each of the pixels 1-C and 1-D is turned off.

During the detection periods T1 to T8, turn-on switch lines 21-1 and 21-2 becomes in the L-level, and, hence, the turn-on switch elements 20 of all the pixels are turned off. The control voltage (Vg) is supplied from the signal line driver circuit 9 to the signal lines 12-1 and 12-2.

During the period T1, the current source selection line 51-1 becomes in the H-level, and the current source selection line 51-2 becomes in the L-level. Hence, the current source selection switch element 50-1 is turned on, and the current source selection switch element 50-2 is turned off.

Further, the pixel selection line 53-1 becomes in the H-level, and the pixel selection line 53-2 becomes in the L-level. Hence, the pixel selection switch element 52-1 is turned on, and the pixel selection switch element 52-2 is turned off. Therefore, the source electrode of the driving TFT 4 of each of the pixels 1-A and 1-C is connected to the current source 33-1, and the source electrode of the driving TFT 4 of each of the pixels 1-B and 1-D is in the floating state.

Therefore, during the period T1, the constant current Ioled1 is supplied to the driving TFT 4 of the pixel 1-A through a path including the driving TFT 4, the turn-on switch elements 20, the current supply line 13, and the current source 33-1. The source voltage V1 of the driving TFT 4 of the pixel 1-A is detected by the detection section DET.

During the next period T2, the current source selection line 51-1 becomes in the L-level, and the current source selection line 51-2 becomes in the H-level. Hence, the current source selection switch element 50-1 is turned off, and the current source selection switch element 50-2 is turned on.

Therefore, during the period T2, the constant current Ioled2 is supplied to the driving TFT 4 of the pixel 1-A through the path including the driving TFT 4, the turn-on switch elements 20, the current supply line 13, and the current source 33-2. The source voltage V2 of the driving TFT 4 of the pixel 1-A is detected by the detection section DET.

Subsequently, during the periods T3 and T4, while the pixel selection switch element 52-1 is turned off, and the pixel selection switch element 52-2 is turned on, the same operation as described above is performed. Thus, the source voltages (V1 and V2) of the driving TFT 4 of the pixel 1-B, in the cases where the constant currents Ioled1 and Ioled2 are supplied to the driving TFT 4 of the pixel 1-B through the path including the driving TFT 4, the turn-on switch elements 20, the current supply line 13, and the current sources 33-1 and 33-2, are detected by the detection section DET.

During the periods T5 to T8, the selection switch element 32 and the detection switch element 22 in each of the pixels 1-A and 1-B are turned off, and the selection switch element 32 and the detection switch element 22 in each of the pixels 1-C and 1-D are turned on. In this case, when the same operation as described above is executed, the constant current Ioled1 is supplied to the driving TFT 4 of each of the pixels 1-C and 1-D through the path including the driving TFT 4, the turn-on switch elements 20, the current supply line 13, and the current source 33-1. The source voltages (V1 and V2) of the driving TFTs 4 of the pixels 1-C and 1-D are detected by the detection section DET.

In addition, in each of the embodiments described above, a single current source instead of the two current sources 33-1 and 33-2 may be used to switch a current value of the single current source between the current values Ioled1 and Ioled2.

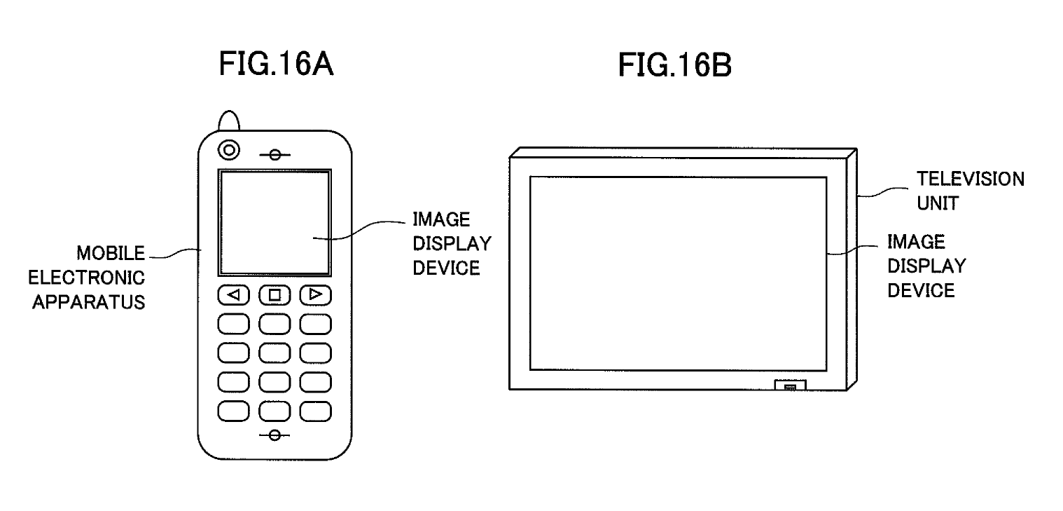

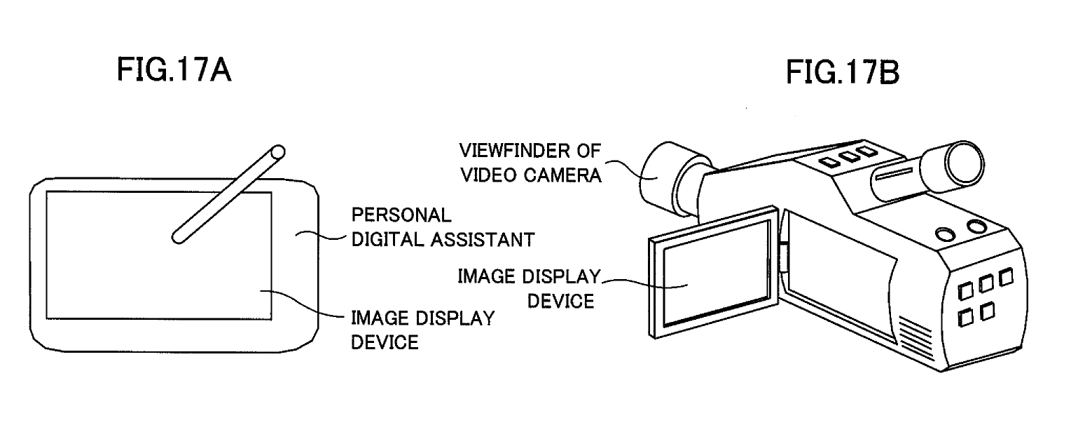

By employing any one of the above-mentioned image display devices according to the present invention in a mobile electronic apparatus illustrated in FIG. 16A, a television unit illustrated in FIG. 16B, a personal digital assistant (PDA) illustrated in FIG. 17A, or a video camera illustrated in FIG. 17B, a high-quality product for moving pictures may be realized.

While there have been described what are at present considered to be certain embodiments of the invention, it will be understood that various modifications may be made thereto, and it is intended that the appended claim cover all such modifications as fall within the true spirit and scope of the invention.

What is claimed is:

1. An image display device comprising:
a plurality of pixels;
a plurality of signal lines for respectively supplying an image voltage to each of the plurality of pixels,
wherein each of the plurality of pixels includes:
a self light-emitting element;
a driving transistor configured to drive the self light-emitting element based on the image voltage inputted, wherein the driving transistor is a p-type thin film transistor;
a holding capacitor element connected between a source electrode of the driving transistor and thereof; and
a selection switch element connected between corresponding one of the plurality of signal lines and the gate electrode of the driving transistor;
a current source configured to supply a constant current to the driving transistor; and
a detection section connected to the source electrode of the driving transistor of each of the plurality of pixels,
wherein the current source is connected to the source electrode of the driving transistor, and
wherein the detection section detects a source voltage of the driving transistor when the constant current is supplied during a detection period.

2. The image display device according to claim 1,
wherein the driving transistor operates in a saturation region, and
wherein a threshold voltage of the driving transistor is detected based on the source voltage of the driving transistor.

3. The image display device according to claim 1, wherein a gate electrode of the selection switch element is connected to a first horizontal address selection circuit and a second horizontal address selection circuit.

4. The image display device according to claim 3,
wherein, when displaying, the first horizontal address selection circuit selects a horizontal address of the plurality of pixels to which the image voltage is inputted, and
wherein, when detecting, the second horizontal address selection circuit selects a horizontal address of the plurality of pixels to be detected.

5. The image display device according to claim 2,
wherein the current source further comprises:
a first current source configured to supply a first current to the driving transistor; and
a second current source configured to supply a second current to the driving transistor,
wherein in a state that a control voltage of a control electrode of the driving transistor is set to a first control voltage, the detection section detects a first source voltage of the driving transistor in a case where the first current is supplied to the driving transistor and a second source voltage of the driving transistor in a case where the second current is supplied to the driving transistor, and
wherein the detection section detects the threshold voltage of the driving transistor based on the first source voltage detected by the detection section, the second source voltage detected by the detection section, and the first control voltage.

6. The image display device according to claim 2,
wherein the current source further comprises:
a first current source configured to supply a first current to the driving transistor; and
a second current source configured to supply a second current to the driving transistor,
wherein when one of two adjacent pixels is regarded as a first pixel, and the other is regarded as a second pixel, in a state that a control voltage of a control electrode of the driving transistor is set to a first control voltage,
the detection section detects:
a third source voltage of the driving transistor of the first pixel in a case where the first current is supplied to the driving transistor of the first pixel;
a fourth source voltage of the driving transistor of the second pixel in a case where the first current is supplied to the driving transistor of the second pixel;
a fifth source voltage of the driving transistor of the first pixel in a case where the second current is supplied to the driving transistor of the first pixel; and
a sixth source voltage of the driving transistor of the second pixel in a case where the second current is supplied to the driving transistor of the second pixel, and
wherein the detection circuit detects a difference voltage between the threshold voltage of the driving transistor of the first pixel and the threshold voltage of the driving transistor of the second pixel based on the third source voltage detected by the detection circuit, the fourth source voltage detected by the detection circuit, the fifth source voltage detected by the detection circuit, and the sixth source voltage detected by the detection circuit.

7. The image display device according to claim 5, wherein a root of a ratio of an amplitude of the first current to an amplitude of the second current is a proportion to 2.

8. The image display device according to claim 5 further comprising:
a plurality of power supply lines;
a plurality of first switches connecting one of the plurality of power supply lines during the detection period;
a plurality of second switches connecting one of the first current source and the second current source to the selected one of the plurality of power supply lines during the detection period; and
a plurality of voltage sources for supplying voltages for displaying to the plurality of power supply lines during a normal display state except for the detection period,
wherein the source electrode of the driving transistor of each of the plurality of pixels is connected to corresponding one of the plurality of power supply lines.

9. The image display device according to claim 8, further comprising a voltage source for supplying the image voltage and a reference voltage to at least one of the plurality of signal lines.

10. The image display device according to claim 1,
wherein the driving transistor operates in a linear region, and
wherein the detection section detects an anode voltage of the self light-emitting element.

11. An image display device comprising:
a plurality of pixels;
a plurality of signal lines for respectively supplying an image voltage to each of the plurality of pixels;
a plurality of current supply lines,
wherein each of the plurality of pixels includes:
a self light-emitting element;
a driving transistor configured to drive the self light-emitting element based on the image voltage inputted, wherein the driving transistor is an n-type thin film transistor;
a holding capacitor element connected between a source electrode of the driving transistor and a gate electrode thereof;
a selection switch element connected between corresponding one of the plurality of signal lines and the gate electrode of the driving transistor; and
a detection switch element connected between corresponding one of the plurality of current supply lines and the source electrode of the driving transistor;
a current source that is connected to the plurality of current supply lines and is configured to supply a constant current to the driving transistor; and
a detection section connected to the source electrode of the driving transistor of each of the plurality of pixels through one of the plurality of current supply lines and the detection switch element,
wherein the detection section detects a source voltage of the driving transistor when the constant current is supplied during a detection period.

12. The image display device according to claim 11,
wherein the driving transistor operates in a saturation region, and
wherein a threshold voltage of the driving transistor is detected based on the detected source voltage of the driving transistor.

13. The image display device according to claim 12, wherein the current source further comprises:
a first current source configured to supply a first current to the driving transistor; and
a second current source configured to supply a second current to the driving transistor,
wherein in a state that a control voltage of a control electrode of the driving transistor is set to a first control voltage, the detection section detects a first source voltage of the driving transistor in a case where the first current is supplied to the driving transistor and a second source voltage of the driving transistor in a case where the second constant current is supplied to the driving transistor, and
wherein the detection section detects the threshold voltage of the driving transistor based on the first source voltage detected by the detection section, the second source voltage detected by the detection section, and the first control voltage.

14. The image display device according to claim 12, wherein the current source further comprises:
a first current source configured to supply a first current to the driving transistor; and
a second current source configured to supply a second current to the driving transistor,
wherein when one of two adjacent pixels is regarded as a first pixel, and the other is regarded as a second pixel, in a state that a control voltage of a control electrode of the driving transistor is set to a first control voltage,
the detection section detects:
a third source voltage of the driving transistor of the first pixel in a case where the first current is supplied to the driving transistor of the first pixel;
a fourth source voltage of the driving transistor of the second pixel in a case where the first current is supplied to the driving transistor of the second pixel;
a fifth source voltage of the driving transistor of the first pixel in a case where the second current is supplied to the driving transistor of the first pixel; and
a sixth source voltage of the driving transistor of the second pixel in a case where the second current is supplied to the driving transistor of the second pixel, and
wherein the detection section detects a difference voltage between the threshold voltage of the driving transistor of the first pixel and the threshold voltage of the driving transistor of the second pixel based on the third source voltage detected by the detection section, the fourth source voltage detected by the detection section, the fifth source voltage detected by the detection section, and the sixth source voltage detected by the detection section.

15. The image display device according to claim 13, wherein a root of a ratio of an amplitude of the first current to an amplitude of the second current is a proportion to 2.

16. The image display device according to claim 13 further comprising:
a plurality of third switches connecting one of the plurality of current supply lines during the detection period; and
a plurality of fourth switches connecting one of the first current source and the second current source to the selected one of the plurality of current supply lines during the detection period.

17. An image display device comprising:
a plurality of pixels, wherein each of the plurality of pixels includes:
a self light-emitting element; and
a driving transistor configured to drive the self light-emitting element based on an inputted image voltage;
a current source configured to supply a constant current to the driving transistor; and
a detection section connected to a source electrode of a driving transistor,
wherein the current source is connected to the source electrode of the driving transistor; and
wherein the detection section detects a source voltage of the driving transistor when the constant current is supplied during a detection period.

18. The image display device according to claim 17,
wherein the constant current comprises first and second currents,
wherein in a state that a control voltage of a control electrode of the driving transistor is set to a first control voltage, the detection section detects a first source voltage of the driving transistor in a case where the first current is supplied to the driving transistor and a second source voltage of the driving transistor in a case where the second current is supplied to the driving transistor, and
wherein the detection section detects the threshold voltage of the driving transistor based on the first source voltage detected by the detection section, the second source voltage detected by the detection section, and the first control voltage.

19. The image display device according to claim 18, wherein a root of a ratio of an amplitude of the first current to an amplitude of the second current is a proportion to 2.

20. The image display device according to claim 1 wherein the detection section comprises:
a buffer circuit configured to receive the source voltage of the driving transistor;
a low-pass filter configured to receive an output from the buffer circuit; and
an A/D converter configured to convert an output from the low-pass filter to a digital signal.
